(19) United States
(12) Patent Application Publication
(10) Pub. No.: US 2024/0203445 A1
(43) Pub. Date: Jun. 20, 2024

(54) FRAMEWORK FOR REGULATING EMOTIONS IN CONVERATIONS

(71) Applicant: International Business Machines Corporation, Armonk, NY (US)

(72) Inventors: Isaiah Mulang' Onando, Nairobi (KE); Julian Bertram Kuehnert, Nairobi (KE); Sekou Lionel Remy, Nairobi (KE); Charles Muchiri Wachira, Karatina (KE); Aisha Walcott, Nairobi (KE)

(73) Assignee: International Business Machines Corporation, Armonk, NY (US)

(21) Appl. No.: 18/081,662

(22) Filed: Dec. 14, 2022

(51) Int. Cl. G10L 25/63; G08B 21/18

(52) U.S. Cl. CPC G10L 25/63; G08B 21/182

(57) ABSTRACT

A method for regulating emotions in conversations is disclosed. In one embodiment, such a method includes monitoring a conversation between participants. The method further divides the conversation into a plurality of utterances and calculates an emotion score for each utterance. The method further determines whether an emotion score of an utterance exceeds a threshold. In the event the emotion score exceeds the threshold, the method intervenes in the conversation in an attempt to return the conversation to a more constructive path. In certain embodiments, this intervention may include taking one or more actions that are specifically tailored to returning the conversation to a more constructive path. In other or the same embodiments, responses or reactions of the participants to the actions are audited to determine if the actions were successful in returning the conversation to a more constructive path. A corresponding system and computer program product are also disclosed.

### BACKGROUND

### Field of the Invention

This invention relates to systems and methods for regulating emotions in conversations.

### Background of the Invention

When conducting a conversation, emotions may arise due to feelings toward a conversation partner and/or the topic of conversation. In some cases, these emotions may create a fight-or-flight response that triggers various physiological responses in the participants, such as higher heart rates, tightening of muscles, sweating, alterations in brain chemistry, and general feelings of discomfort. These physiological responses may undermine rational arguments and/or affect the course or ending of a conversation. In certain cases, letting emotions get out of control may lead to participants saying or doing something that is out of character or that leads to later regrets. In more severe cases, emotions in conversations can lead to medical conditions. At the very least, letting emotions get out of control may affect the mental state of participants and/or their interpersonal relationships.

### SUMMARY

The invention has been developed in response to the present state of the art and, in particular, in response to the problems and needs in the art that have not yet been fully solved by currently available systems and methods. Accordingly, systems and methods have been developed to regulate emotions in conversations. The features and advantages of the invention will become more fully apparent from the following description and appended claims, or may be learned by practice of the invention as set forth hereinafter.

Consistent with the foregoing, a method for regulating emotions in conversations is disclosed. In one embodiment, such a method includes monitoring a conversation between participants. The method further divides the conversation into a plurality of utterances and calculates an emotion score for each utterance. The method further determines whether an emotion score of an utterance exceeds a threshold. In the event the emotion score exceeds the threshold, the method intervenes in the conversation in an attempt to return the conversation to a more constructive path. In certain embodiments, this intervention may include taking one or more actions that are specifically tailored to returning the conversation to a more constructive path. In other or the same embodiments, responses or reactions of the participants to the actions are audited to determine if the actions were successful in returning the conversation to a more constructive path.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the embodiments of the invention will be described and explained with additional specificity and detail through use of the accompanying drawings, in which:

FIG. 1 is a high-level block diagram showing one example of a computing system for use in implementing embodiments of the invention;

FIG. 2 is a high-level block diagram showing operation of an emotion regulation module in accordance with the invention;

FIG. 3 is an exemplary timeline showing how emotions are trending in a conversation;

FIG. 4 is a high-level block diagram showing an exemplary conversation graph;

FIG. 5 is pseudocode showing how conversation graph proximity is determined in relation to a conversation gradient; and

FIG. 6 is a high-level block diagram showing one embodiment of a conversation profile for a participant in a conversation.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as code 150 (i.e., an “emotion regulation module 150”) associated with regulating emotions in conversations. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

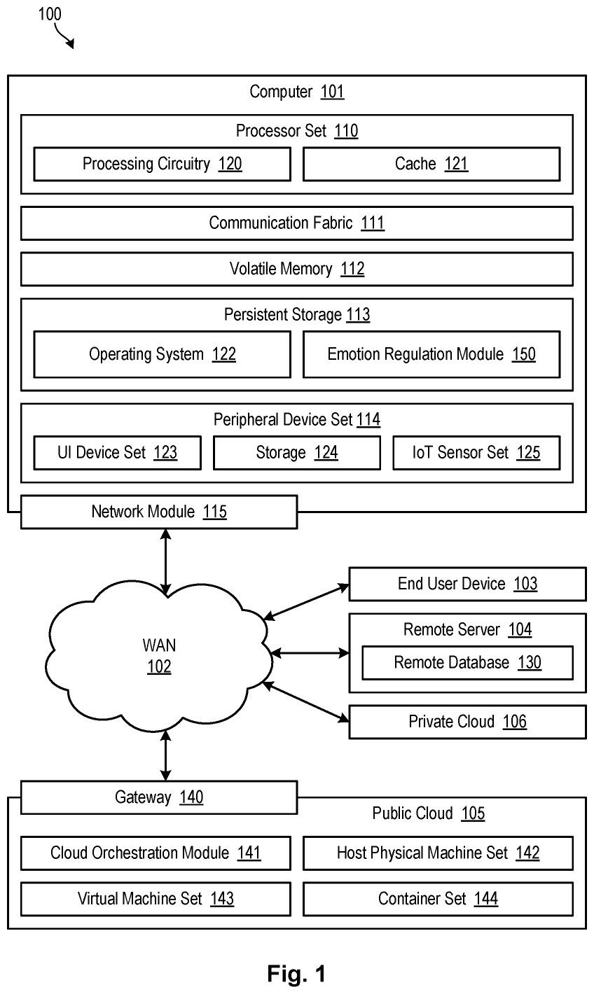

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

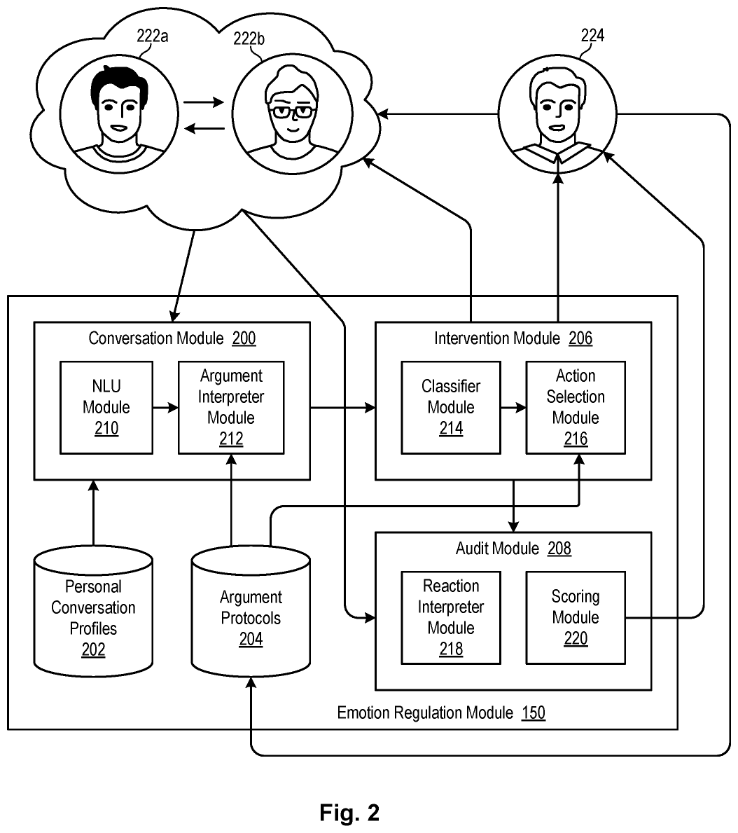

Referring to FIG. 2, a high-level block diagram showing operation of an emotion regulation module 150 in accordance with the invention is illustrated. As shown, the emotion regulation module 150 may include one or more of a conversation module 200, intervention module 206, and audit module 208. The conversation module 200 may include one or more of a natural language processing (NLU) module 210 and an argument interpreter module 212. The intervention module 206 may include one or more of a classifier module 214 and an action selection module 216. The audit module 208 may include one or more of a reaction interpreter module 218 and a scoring module 220. As shown, the conversation module 200 may make use of personal conversation profiles 202. The conversation module 200 and the intervention module 206 may make use of argument protocols 204.

As shown, the conversation module 200 may monitor a conversation between participants 222. The natural language processing module 210 within the conversation module 200 may attempt to understand what the participants 222 are saying in the conversation and divide the conversation into a plurality of utterances. This may be done in view of the participant's personal conversation profiles 202, which helps the conversation module 200 understand the speaking styles and characteristics of the participants 222. For example, an utterance expressed by a first participant may be characterized differently than the same utterance by a second participant based on differences in the participants' speaking styles.

It follows that an utterance by a first participant may represent a significant emotional event that requires some response or intervention while the same utterance by a second participant may not require the same response or intervention. That is, the utterance by the second participant, even though it may be considered emotional by some standards and for some people, may be normal for the participant and may not represent an event where the second participant's emotions are elevated or getting out of control. The personal conversation profiles 202 may assist the conversation module 200 in understanding the speaking styles and characteristics of particular participants 222 that are engaged in a conversation so that the emotional nature of the conversation can be more accurately ascertained.

The argument interpreter module 212 may interpret the utterances gathered or understood by the natural language processing module 210 to determine what arguments are being presented by the participants 222 to determine if the content is becoming overly emotional in a way that might require intervention. In certain embodiments, the argument interpreter module 212 may determine whether the emotions in an utterance have reached a particular threshold that requires intervention.

In the event emotions in a particular utterance have reached an emotional threshold, the intervention module 206 may be invoked. In particular, the classifier module 214 within the intervention module 206 may classify the types of emotions (e.g., anger, sadness, anxiety, contempt, hostility, etc.) that are in the utterance and determine what actions may be required. In making this determination, the intervention module 206 may draw from argument protocols 204 that may define various types of arguments and what actions are needed to get those types of arguments back on track or onto a more constructive path. In certain embodiments, the argument protocols 204 may be derived from the social sciences that describe various methods of argumentation and what actions should or may be taken when such arguments get off track due to emotions or other reasons. In certain embodiments, the argument protocols 204 make up a knowledge base that is incorporated into the intervention module 206 and that designates what actions to take or advice to give in a particular context in order to get a conversation back onto a constructive path or to reduce emotions in a conversation. Based on the types of actions that are set forth in the argument protocols 204, the action selection module 216 may select an action or actions to take.

Based on the action selected by the action selection module 216, the intervention module 206 may intervene in the conversation in attempt to get the conversation on a more constructive path. In certain embodiments, this may be as simple as sending a text (SMS) message to a participant's mobile phone or causing the participant's mobile phone to vibrate. In certain embodiments, the message may notify the participant 222 that the conversation has gotten off track as a result of emotions and/or provide instructions to one or more of the participants 222 as to how to get the conversation back on a more constructive path. In other or the same embodiments, a caregiver 224 may be notified and/or provided instructions. This may enable the caregiver 224 to also intervene in the conversation to get the conversation on a more constructive path, and/or work with a participant 222 at some later point in time to manage emotions or argue in a more constructive manner. In certain embodiments, the intervention module 206 may gather information such as by capturing screenshots or saving a recording of a conversation in order to document where a conversation got out of control or emotions became elevated.

The audit module 208 may evaluate the effects of the actions taken by the intervention module 206. For example, a reaction interpreter module 218 within the audit module 208 may determine whether the actions were able to redirect the conversation to a more constructive path or lower the emotions in the conversation to a more constructive level. In certain embodiments, the scoring module 220 may score the reaction, thereby indicating how effective the actions were. The audit module 208 may also, in certain embodiments, provide feedback to a caregiver 224 as to whether the actions were successful. In certain embodiments, the feedback generated by the audit module 208 may be used to improve the knowledge base 204 and indicate which actions were successful and which were less successful at regulating emotions in a conversation. Thus, the emotion regulation module 150 may be configured to continually refine and improve the actions that are taken in response to various emotions.

The emotion regulation module 150 may improve the functioning of a computing system in that it may make the computing system more human-like. More specifically, the computing system may, like a human caregiver 224, be configured to recognize emotions in the conversations of other humans and intervene in those conversations when emotions have gotten or are getting out of control in order to bring the conversations back onto a more constructive path.

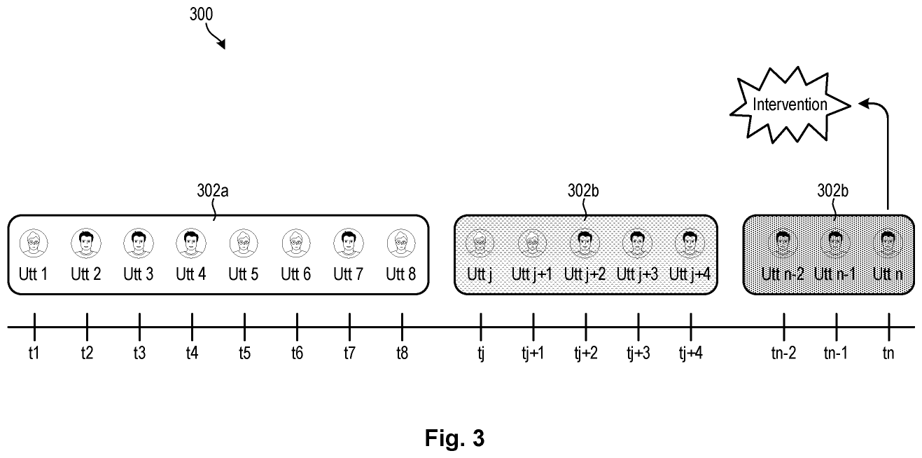

Referring to FIG. 3, an exemplary timeline 300 is provided to show how emotions may trend in a conversation. As shown, the emotion regulation module 150 may monitor a conversation over time by dividing the conversation into a plurality of utterances made by the participants 222 in a conversation. In certain embodiments, a trend state variable is maintained for the conversation to determine how emotions are trending in the conversation over time. At given time intervals, the trend state variable may be updated based on the current state of the conversation.

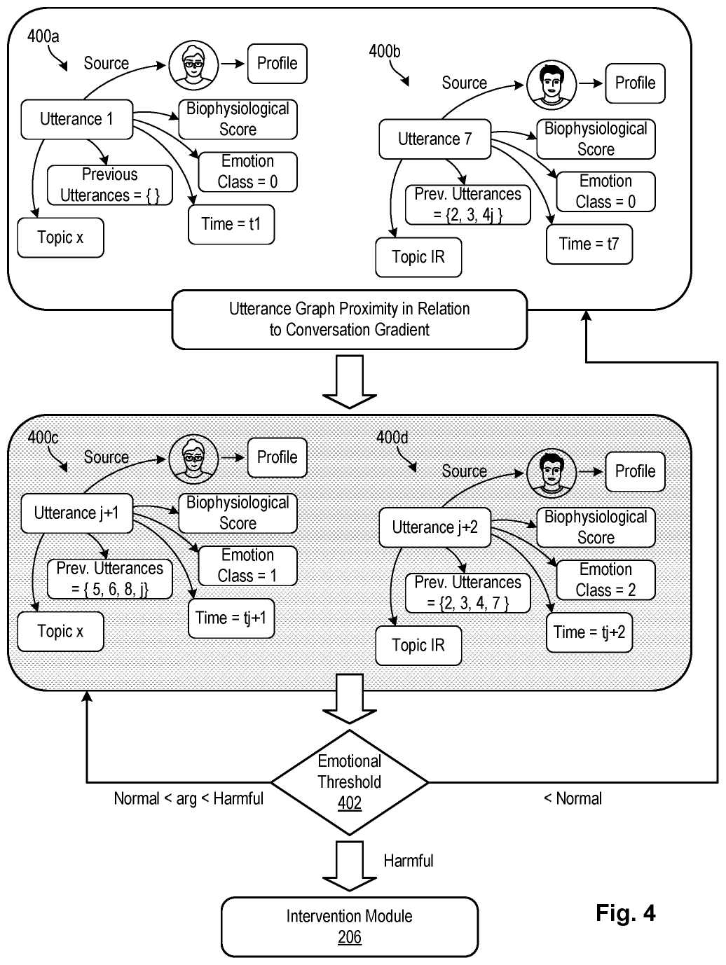

As shown in FIG. 3, during time intervals t1-t8, which are associated with utterances Utt1-Utt8, the trend state variable is in a first state 302a wherein the emotional content of the conversation is in a relatively mild (i.e., non-emotional) state. The trend state variable then transitions at time tj to a second state 302b wherein the emotional content of the conversation is elevated but does not yet rise to a level requiring intervention. In this example, the trend state variable remains in this second state 302b until time tj+4. Upon reaching time tn−2, the trend state variable rises to a third state 302b where the emotional content of the conversation is highly elevated. At this point, the conversation may no longer be on a constructive path. If the conversation remains in this state, the emotion regulation module 150 may intervene in the conversation to try to bring the conversation back to either state 302a or state 302b, but ideally state 302a. As will be shown in FIG. 4, the value of the trend state variable may be based on various factors or attributes of the utterances. In certain embodiments, the value of the trend state variable may be referred to as an “emotion score.” When the emotion score reaches a selected threshold, the emotion regulation module 150 may be configured to intervene in the conversation.

Referring to FIG. 4, in certain embodiments, the utterances of a conversation may be represented as nodes 400 in a conversation graph. In certain embodiments, the natural language processing module 210 may be configured to dynamically build this conversation graph. The natural language processing module 210 may help define the semantics of each utterance in this conversation graph. The argument interpreter module 212 utilizes the results from the natural language processing module 210, the personal conversation profiles 202, and the argument protocols 204 to classify the emotion and produce an emotion score for each utterance. A threshold may be set to determine when the emotion score has surpassed sustainable levels. When the emotion score reaches the threshold, the intervention module 206 may be called upon to intervene in the conversation.

As shown, each of the nodes 400 (or utterances) have associated therewith various attributes such as a personal conversation profile 202 of the participant 222 that made the utterance. Each node 400 may also have a biophysiological score that depends on biophysiological attributes of the participant 222 such as body posture, gestures, facial expressions, voice intonation, and possibly measurement such as heart rate, blood pressure, perspiration, and the like, which may be measured with a wearable device, for example. Each node 400 may also be assigned an emotion class that identifies an emotion associated with an utterance and/or how elevated the emotion is. Each node 400 may also have a time associated therewith, a list of previous utterances made by the same participant 222 up to some time limit, and a topic that is being discussed in association with the utterance. As previously mentioned, each of these attributes may be taken into account when calculating the trend state variable for each utterance.

When multiple utterances are made in sequence, an utterance graph proximity value may quantify how close the utterances are to one another. A conversation gradient, by contrast, may indicate whether the conversation is moving from positive to positive, positive to negative, negative to negative, or negative to positive. As shown in FIG. 4, the utterance graph proximity may be determined in relation to the conversation gradient. This score is a measure of the emotional distance between two utterances represented as graphs.

At step 402, the emotion score of an utterance may be compared to an emotional threshold. If the conversation is normal and the emotional threshold has not been reached, then no intervention is necessary. If the conversation is more emotional than normal but is still not harmful and the emotional threshold has not been reached, no intervention may be necessary. On the other hand, if the conversation is harmful and the emotional threshold is reached, the intervention module 206 may be called to intervene in the conversation.

Among other applications, embodiments of the invention may be useful in monitoring conversations and intervening in such conversations when required in online forums, discussion boards, social media applications, couples therapy, family therapy, domestic violence and surveillance settings, emotional intelligence training sessions, sessions for quenching anxiety and fear, and the like. The applications may include both verbal and written as emotional content may be monitored and interventions may be performed in either application.

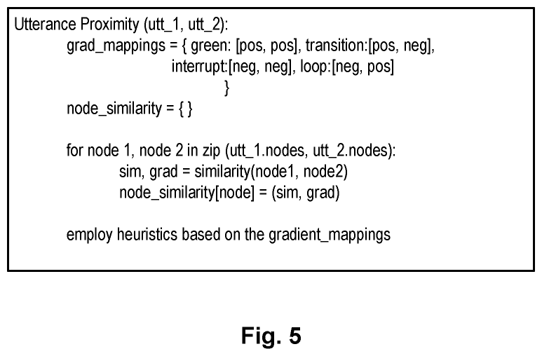

Referring to FIG. 5, an algorithm to calculate utterance graph proximity in relation to the conversation gradient is shown in pseudocode. The conversation gradient indicates the general direction of a conversation which typically takes four different forms based on the emotion states of utterances namely: positive to positive, positive to negative, negative to negative, and negative to positive. The utterance graph proximity is a similarity score obtained by a weighted or aggregate proximity scores of the nodes for any pair of utterance graphs from the conversation participants. Such graphs and graph nodes can be represented using vector space representations using techniques such as Graph Neural Networks (GNNs) to enhance computations. This proximity score is used to determine if the conversation should transition between normal, mild emotion, or disruptive emotion in accordance with the gradient.

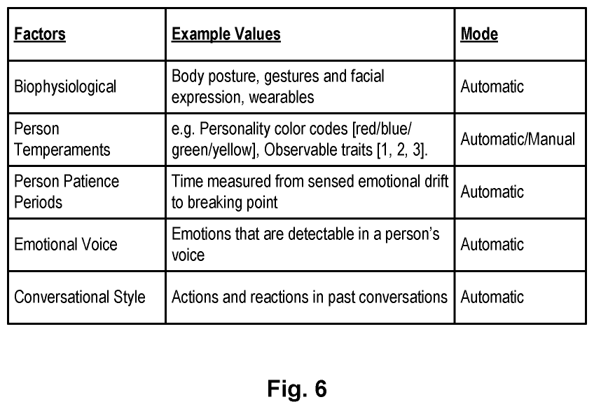

Referring to FIG. 6, one embodiment of a personal conversation profile 202 for a participant in a conversation is illustrated. As previously mentioned, the personal conversation profile 202 may assist the conversation module 200 in understanding the speaking style and characteristics of a participant 222 to a conversation so that emotions may be determined. Among other factors, the personal conversation profile 202 may take into account the biophysiological characteristics of a participant 222 such as the participant's body posture, gestures, facial expressions, as well as characteristics that may be measured with a wearable device. The personal conversation profile 202 may also take into account a temperament of the participant 222. This temperament, for example, may be represented as personality color codes of the participant 222. The personal conversation profile 202 may also take into account a participant's patience period. This may involve measuring an amount of time that elapses from a participant experiencing emotional drift to the participant reaching a breaking point. The personal conversation profile 202 may also take into account emotions that may be detectable in a participant's voice. The personal conversation profile 202 may take into account the conversation style of the participant 222 which may, in certain embodiments, be determined by how the participant acted or reacted in past conversations. The right-hand column of FIG. 6 shows whether the listed factors are captured automatically or manually in the personal conversation profile 202.

The flowcharts and block diagrams in the Figures illustrate the architecture, functionality, and operation of possible implementations of systems, methods, and computer program products according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other implementations may not require all of the disclosed steps to achieve the desired functionality. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for regulating emotions in conversations, the method comprising:
monitoring a conversation between participants;
dividing the conversation into a plurality of utterances;
calculating an emotion score for each utterance;
determining whether an emotion score of an utterance exceeds a threshold; and
intervening in the conversation in the event the emotion score exceeds the threshold.

2. The method of claim 1, wherein monitoring comprises monitoring in real time.

3. The method of claim 1, wherein intervening comprises notifying at least one of the participants in the event the emotion score exceeds the threshold.

4. The method of claim 1, wherein intervening comprises notifying at least one of the participants of a recommended course of action.

5. The method of claim 4, wherein the recommended course of action is based on at least one of a type of argument in the utterance, a user profile of a participant that produced the utterance, a topic of the utterance, intonation of a participant that produced the utterance, and a physiological response of a participant that produced the utterance.

6. The method of claim 1, further comprising modeling the utterances as nodes in a conversation graph.

7. The method of claim 1, further comprising evaluating responses of the participants to the intervention.

8. A computer program product for regulating emotions in conversations, the computer program product comprising a computer-readable storage medium having computer-usable program code embodied therein, the computer-usable program code configured to perform the following when executed by at least one processor:
monitor a conversation between participants;
divide the conversation into a plurality of utterances;
calculate an emotion score for each utterance;
determine whether an emotion score of an utterance exceeds a threshold; and
intervene in the conversation in the event the emotion score exceeds the threshold.

9. The computer program product of claim 8, wherein monitoring comprises monitoring in real time.

10. The computer program product of claim 8, wherein intervening comprises notifying at least one of the participants in the event the emotion score exceeds the threshold.

11. The computer program product of claim 8, wherein intervening comprises notifying at least one of the participants of a recommended course of action.

12. The computer program product of claim 11, wherein the recommended course of action is based on at least one of a type of argument in the utterance, a user profile of a participant that produced the utterance, a topic of the utterance, intonation of a participant that produced the utterance, and a physiological response of a participant that produced the utterance.

13. The computer program product of claim 8, wherein the computer-usable program code is further configured to model the utterances as nodes in a conversation graph.

14. The computer program product of claim 8, wherein the computer-usable program code is further configured to evaluate responses of the participants to the intervention.

15. A system for regulating emotions in conversations, the system comprising:
at least one processor;
at least one memory device operably coupled to the at least one processor and storing instructions for execution on the at least one processor, the instructions causing the at least one processor to:
monitor a conversation between participants;
divide the conversation into a plurality of utterances;
calculate an emotion score for each utterance;
determine whether an emotion score of an utterance exceeds a threshold; and
intervene in the conversation in the event the emotion score exceeds the threshold.

16. The system of claim 15, wherein monitoring comprises monitoring in real time.

17. The system of claim 15, wherein intervening comprises notifying at least one of the participants in the event the emotion score exceeds the threshold.

18. The system of claim 15, wherein intervening comprises notifying at least one of the participants of a recommended course of action.

19. The system of claim 18, wherein the recommended course of action is based on at least one of a type of argument in the utterance, a user profile of a participant that produced the utterance, a topic of the utterance, intonation of a participant that produced the utterance, and a physiological response of a participant that produced the utterance.

20. The system of claim 15, wherein the instructions further cause the at least one processor to model the utterances as nodes in a conversation graph.
